(19) United States
(12) Patent Application Publication
(10) Pub. No.: US 2025/0026057 A1
(43) Pub. Date: Jan. 23, 2025

(54) MOLDS, MOLD ASSEMBLIES AND STACK COMPONENTS

(71) Applicant: Husky Injection Molding Systems Ltd., Bolton (CA)

(72) Inventors: Ralf Walter FISCH, Saarburg (DE); Heikki Sakari HYVARINEN, Mississauga (CA)

(73) Assignee: Husky Injection Molding Systems Ltd., Bolton, ON (CA)

(21) Appl. No.: 18/714,405

(22) PCT Filed: Nov. 25, 2022
(86) PCT No.: PCT/CA2022/051729

§ 371 Date: May 29, 2024

Related U.S. Application Data
(60) Provisional application No. 63/267,574, filed on Feb. 4, 2022.
(60) Provisional application No. 63/264,618, filed on Nov. 29, 2021.

(51) Int. Cl. B29C 45/36; B29C 45/26; B29C 45/32; B29L 31/00

(52) U.S. Cl. CPC B29C 45/36; B29C 45/2606; B29C 45/261; B29C 45/32; B29C 2045/363; B29L 2031/712

(57) ABSTRACT

A mold assembly (100) for making tubular articles. The mold assembly includes a core plate (210), core inserts (230) mounted to the core plate (210) by fasteners (B), a cavity plate (410) with holes (413) through its thickness and cavity inserts (420) mounted to the cavity plate (410). Each core insert (230) has a molding surface (234a) and an engagement taper (233) between the molding surface and its mounting surface (236). At least part of the engagement taper (233) is located closer to the mounting surface (236) than it is to the molding surface (234a) for inhibiting the core insert (230) from tipping when the engagement taper (233) is engaged to move or slide the core insert (230) along the core plate (210). The assembly (100) has an assembled configuration, in which the core plate (210) is mounted to the a cavity plate (410), such that each core insert (230) describes with a respective cavity insert (420) a hollow body and each cavity plate hole (413) is aligned with a respective core insert fastener (B) for allowing a tool to be inserted therethrough to access the core insert fastener (B).

### FIELD OF THE INVENTION

This invention relates generally to molding apparatus and associated methods. More specifically, although not exclusively, this invention relates to mold stacks, mold assemblies, molds, molding systems for molding tubular articles, such as vials, and to associated methods.

### BACKGROUND OF THE INVENTION

Molding is a process by virtue of which a molded article can be formed from molding material, such as a plastics material, by using a molding system, such as an injection molding system or a compression molding system. Various molded articles can be formed by using such molding processes including, for example, vials for medical applications.

As an illustration, injection molding of vials involves heating a polymeric material to a homogeneous molten state and injecting, under pressure, the so-melted material into a molding cavity defined, at least in part, by a female cavity piece and a male core piece. Typically, the female cavity piece is mounted to a cavity plate and the male core piece is mounted to a core plate of a mold. The cavity plate and the core plate are urged together and are held together by clamp force, the clamp force being sufficient to keep the cavity and the core pieces together against the pressure of the injected material. The molding cavity has a shape that substantially corresponds to a final cold-state shape of the molded article to be molded. The so-injected material is then cooled to a temperature sufficient to enable removal of the so-formed molded article from the molding cavity. When cooled, the molded article shrinks inside of the molding cavity and, as such, when the cavity and core plates are urged apart, the molded article tends to remain associated with the core piece.

Accordingly, by urging the core plate away from the cavity plate, the molded article can be subsequently demolded by ejecting it off the core piece. Ejection structures are known to assist in removing the molded articles from the core halves. Examples of the ejection structures include stripper plates, stripper rings or sleeves, neck rings, ejector pins, etc.

A typical molding insert stack assembly that can be arranged (in use) within a molding machine includes a stripper sleeve that, together with a mold cavity insert, a gate insert and a core insert, defines a molding cavity. The stripper sleeve generally defines an outer portion of an open end of the tubular article. Molding material can be injected into the molding cavity from a source of molding material via a receptacle or port in the gate insert to form a molded article. In order to facilitate removal of the molded article from the core, the stripper sleeve is mounted on a top surface of a stripper plate.

As commonly known, the stripper plate is configured to be movable relative to the cavity insert and the core insert, when the mold is arranged in an open configuration. One of the functions performed by the stripper sleeve is to assist in ejecting the molded article off the core insert by “sliding” the molded article off the core insert. More specifically, the stripper sleeve, which is mounted on the stripper plate, can be driven along the axis of the core by the movement of the stripper plate, thereby to release the molded article from the molding cavity.

### SUMMARY OF THE INVENTION

The present invention seeks to provide an alternative arrangement for securing stack components of a mold for molding articles, specifically but not exclusively tubular articles such as vials. This invention is directed, in particular but not exclusively, to mold stacks, molds, mold assemblies, molding systems and associated methods. In the case of tubular articles such as vials, the articles may have a base portion at a closed end, an open end and a body portion therebetween. Any of the foregoing features described in relation to known mold stacks, molds and molding systems may be incorporated within mold stacks, molds and molding systems according to the invention, insofar as they are consistent with the disclosure herein.

According to a first broad aspect of the invention, there is provided a mold assembly, e.g. for making tubular articles such as vials. The assembly may comprise a core plate. The assembly may comprise one or more core inserts. The or each core inserts may be mounted to the core plate, e.g. at first of its longitudinal ends. The or each core insert may comprise a molding surface. The molding surface may describe an inner surface of a hollow body. The or each core insert may comprise an engagement taper. The engagement taper may be between the molding surface and the first longitudinal end. At least part of the engagement taper may be located closer to the first longitudinal end than it is to the molding surface, e.g. for inhibiting the core insert from tipping when the engagement taper is engaged to move or slide the core insert along the core plate.

The mold assembly may comprise or be a core plate assembly. The core plate assembly may be for incorporation into a mold.

The or each core insert may comprise a molding portion, which may comprise the molding surface. The or each core insert may comprise a mounting portion, e.g. for mounting the core insert to the core plate. The mounting portion may comprise a mounting flange, which may be at the first longitudinal end of the core insert. The mounting flange may be configured to receive a core insert fastener, e.g. to secure the core insert to a core plate. The mounting flange may comprise the or an engagement taper, which may cooperate with an engagement taper of a further mold insert.

Another broad aspect of the invention provides core insert, e.g. for use in a mold or mold assembly such as that which is described above. The core insert may comprise a molding portion, which may describe an inner surface of a hollow body. The core insert may comprise a molding portion, which may include the molding surface. The core insert may comprise a mounting portion, e.g. for mounting the core insert to a core plate. The mounting portion may comprise a mounting flange, which may be at a first longitudinal end of the core insert. The mounting flange may be configured to receive a fastener, e.g. to secure the core insert to a core plate. The mounting flange may comprise an engagement taper, which may be between the molding surface and the mounting flange, e.g. for engaging a cooperating engagement taper of a further mold insert. At least part of the engagement taper may be located closer to the first longitudinal end than it is to the molding surface.

The core insert preferably has a mounting surface or flange that is wide enough, or large enough in plan, to inhibit the core insert from tipping when the engagement taper is engaged to move or slide the core insert along the core plate and/or into alignment with the further mold insert. In this regard, the relationship between the width of the flange and the longitudinal distance from the first longitudinal end of the core insert to the engagement taper, or the longitudinal centre of the engagement taper, is important. The wider the mounting flange is relative to this longitudinal distance, the more stable and/or resistant to tipping the core insert will be when it is aligned with the further mold insert.

The mounting flange of the or each core may have a radial dimension. The radial dimension may be at least one fifth or 20% or one quarter or 25% of the distance from the first longitudinal end to a longitudinal centre of the engagement taper. The radial dimension may be at least 30% or one third or 33% of the distance from the first longitudinal end to a longitudinal centre of the engagement taper. The radial dimension may be at least half or 50% of the distance from the first longitudinal end to a longitudinal centre of the engagement taper. The radial dimension may be at least 60% or two thirds or 67% of the distance from the first longitudinal end to a longitudinal centre of the engagement taper. The radial dimension may be at least 70% or three quarters or 75% of the distance from the first longitudinal end to a longitudinal centre of the engagement taper. The radial dimension may be at least 80% or 90% of, or at least equal to, the distance from the first longitudinal end to a longitudinal centre of the engagement taper.

The radial dimension preferably comprises a minimum radial dimension, but it may comprise a maximum radial dimension. The mounting flange may be substantially polygonal, e.g. square or rectangular, in plan. The minimum radial dimension may comprise half of the width or shortest width of the mounting flange. The maximum radial dimension may comprise half of the diagonal dimension, e.g. from one corner of the polygon to an opposed corner thereof.

The mounting flange may comprise the or a mounting surface, for example at the first longitudinal end of the core insert. The mounting surface may be at or provide a terminal end of the core insert. The mounting surface may be free of any projections, e.g. thereby to enable the core inserts to slide relative to the core plate along the or a sliding interface, for example when the core inserts are in the movable or floating condition. Alternatively, the mounting portion or flange may comprise a spigot, which may extend from the mounting surface and/or may be received or receivable within a seat of the or a core plate.

The spigot may be smaller than the seat of the core plate within which it is received or to be received, e.g. thereby to enable the core inserts to slide relative to the core plate along the or a sliding interface, for example when the core inserts are in the movable or floating condition. The difference between the diameter of the spigot and that of the seat of the core plate, within which the spigot is received or to be received, may be between 0.05 mm and 4 mm, but is preferably between 0.1 mm and 2 mm. A difference of between 0.1 mm and 0.5 mm has been found to be particularly advantageous. The spigot may comprise a diameter that is at least 0.05 mm, preferably at least 0.1 mm, smaller than the seat of the core plate within which it is received or to be received. Preferably, the spigot comprises a diameter that is at most 4 mm, more preferably at most 2 mm, e.g. at most 0.5 mm, smaller than the seat of the core plate within which it is received or to be received. Thus, the average radial clearance between the spigot and the seat is between 0.025 mm and 2 mm, preferably between 0.05 mm and 1 mm and a range of between 0.05 mm and 0.25 mm has been found to be particularly advantageous. At least one or each core insert, e.g. the mounting surface thereof, may comprise an opening for receiving a core cooling tube.

The molding surface may describe a second longitudinal end of the core insert. The core insert may be hollow. The assembly may comprise a core cooling tube, which may be received within the core and/or may extend to or toward an internal portion of the second longitudinal end of the core insert. The second end of the core may comprise a closed end, which may, but need not, be substantially hemispherical. The core cooling tube may have an open end and/or may be received within the core such that a cooling medium may flow, in use, through the core cooling tube toward the second longitudinal end of the core insert and/or may flow back along the outside of the core cooling tube, e.g. toward the first end of the core insert. The core plate may comprise one or more cooling channels, e.g. for feeding a cooling medium such as water to the cores, for example via the core cooling tubes. The core cooling tube may comprise an inlet portion, e.g. for receiving cooling fluid from the one or more cooling channels of the core plate.

The core plate may comprise a seal surrounding an outlet of the or each cooling channel, e.g. for supplying cooling medium to the or each core. The seal may be for sealing against the mounting surface of the or a respective core insert. The core plate may comprise one or more grooves, which may surround the or each outlet and/or which may receive the or a respective seal. The seal may comprise an O-ring seal.

The engagement taper of the core insert may comprise a male taper. The mold may comprise an assembled configuration. The engagement taper of at least one of the further mold inserts may comprise a female taper, for example with which the engagement taper of the core insert may engage, e.g. when the mold is in the assembled configuration.

The or each core insert may be mounted to the core plate, e.g. by fastening means. The mold assembly may comprise at least one further mold plate. The mold assembly may comprise one or more further mold inserts, which may be mounted to the or each further mold plate. The or each further mold insert may comprise an engagement taper. When the mold assembly is in the assembled configuration, the core plate may be mounted to the further mold plate(s), e.g. with the fastening means therebetween, such that each core insert describes with a respective further mold insert at least part of a hollow body. In the assembled configuration, the engagement taper of the or each core insert may be in engagement, e.g. either directly or indirectly, with the engagement taper of at least one of the further mold insert(s).

At least one of the further mold plate(s) may have one or more holes through its thickness. When the mold assembly is in the assembled configuration, the or each hole may be aligned with a respective core insert fastening means, e.g. for allowing a tool to be inserted therethrough to access and/or operate the core insert fastening means. Additionally or alternatively, the fastening means may be accessible or operable from a rear side of the further plate and/or without access to a front side of the core plate when the assembly is in the assembled configuration and/or when the assembly is incorporated in an assembled mold. Alternatively, the fastening means may be accessible or operable from a rear side of the core plate.

The further plate may comprise a cavity plate. The assembly may comprise one or more cavity inserts. The or each cavity insert may be mounted to the cavity plate. When the mold assembly is in the assembled configuration, the core plate may be mounted to the cavity plate such that each core insert describes with a respective cavity insert at least part of a hollow body.

Another broad aspect of the invention provides a mold assembly, e.g. for making tubular articles such as vials, the assembly comprising: a core plate; one or more core inserts each mounted to the core plate by a fastening means; a cavity plate with one or more holes through its thickness; and one or more cavity inserts mounted to the cavity plate; wherein the assembly comprises an assembled configuration in which the core plate is mounted to the a cavity plate such that each core insert describes with a respective cavity insert at least part of a hollow body and the or each cavity plate hole is aligned with a respective core insert fastening means for allowing a tool to be inserted therethrough to access and/or operate the core insert fastening means.

Yet another broad aspect of the invention provides a mold assembly, e.g. for making tubular articles such as vials, the assembly comprising: a core plate; one or more core inserts each mounted to the core plate by a fastening means; a cavity plate; and one or more cavity inserts mounted to the cavity plate; wherein the assembly comprises an assembled configuration in which the core plate is mounted to the a cavity plate such that each core insert describes with a respective cavity insert at least part of a hollow body and the fastening means is accessible or operable from a rear side of the further plate and/or without access to a front side of the core plate when the assembly is in the assembled configuration.

The fastening means may comprise a fastener. The fastener may be threaded or comprise a threaded fastener, such as a bolt or screw.

Alternatively, the fastening means may comprise a clamping mechanism. The clamping mechanism may be operable to releasably clamp, in use, the core insert(s) to secure it or them from the floating condition to the fixed condition. The clamping mechanism may be operable manually. Alternatively, the clamping mechanism may comprise an actuator. The actuator may comprise a hydraulic actuator and/or may be operated hydraulically. The actuator may comprise a pneumatic actuator and/or may be operated pneumatically. The actuator may comprise a magnetic actuator and/or may be operated magnetically.

The fastening means may be operable, for example when the assembly is in the assembled configuration, to secure the or each core insert to a fixed condition, e.g. from a movable or floating condition. The or each core insert may be substantially immovable relative to the core plate in the fixed condition. The or each core insert may be movable along and/or relative to the core plate in the movable or floating condition. The or each core insert may be able to move or slide relative to the core plate, for example along a sliding interface therebetween, in the movable or floating condition.

Operating the fastening means may comprise tightening the fastening means. When the fastening means comprises a threaded fastener, the core plate may comprise one or more holes, e.g. threaded holes. The holes may be on the front or cavity-facing side of the core plate. The or each threaded hole may be aligned with a corresponding hole in the or each core insert. The or each threaded hole may be positioned and/or configured to receive the or a respective fastener. The or each fastener may extend through the corresponding hole in the or each core insert, e.g. and into the threaded hole.

At least one or each core insert may be mounted to the or a front or cavity-facing surface of the core plate. At least one or each core insert may have a mounting surface, which may cooperate with the front or cavity-facing surface of the core plate to provide the or a sliding interface.

In some embodiments, the or each hole of the core insert(s) is threaded. In such embodiments, the core plate may comprise one or more through holes, which may be aligned with the hole(s) of the core insert and/or receive or be configured to receive a threaded fastener. In such embodiments, the threaded fastener(s) may be operable from a rear side of the core plate. More specifically, the threaded fastener(s) may comprise a socket accessible from a rear side of the core plate.

The assembly may comprise a stripper plate. The stripper plate may be between the core plate and cavity plate. The assembly may comprise one or more stripper sleeves. The or each stripper sleeve may be mounted to the stripper plate. The stripper plate may comprise one or more holes, e.g. through its thickness. The or each hole of the stripper plate may be aligned with the or a respective hole of the cavity plate, e.g. for allowing the tool to be inserted therethrough to access and/or operate the core insert fastener.

The or each stripper sleeve may comprise a first side. The first side may comprise a first engagement taper, which may cooperate with an engagement taper of the cavity insert. The or each cavity insert may comprise an engagement taper that may cooperate with the first engagement taper of the or a respective stripper sleeve. The stripper sleeve may comprise a second side with a second engagement taper which cooperates with an engagement taper of a core insert.

The second engagement taper of the stripper sleeve may comprise a female taper. The second engagement taper of the stripper sleeve may extend from the second side. The second engagement taper of the stripper sleeve may extend along at least half of the length of the stripper sleeve.

Another broad aspect of the invention provides a stripper sleeve, e.g. for use in a mold or mold assembly such as that which is described above. The stripper sleeve may comprise a first side, which may have a first engagement taper, e.g. for cooperating with an engagement taper of a cavity insert. The stripper sleeve may comprise a second side, which may have a second engagement taper, e.g. for cooperating with an engagement taper of a core insert. The second engagement taper may comprise a female taper. The second engagement taper may extend from the second side along at least half of the length of the stripper sleeve.

The first engagement taper of the stripper sleeve may comprise a male taper and/or the engagement taper of the cavity insert may comprise a female taper. Alternatively, the first engagement taper of the stripper sleeve may comprise a female taper and/or the engagement taper of the cavity insert may comprise a male taper.

The assembly may comprise at least one vent passage, which may be described between the or each core and the or a respective stripper sleeve. The or at least one vent passage may be described between the engagement taper of the core insert and the second engagement taper of the stripper sleeve. The vent passage may be described in part by at least one groove on the core insert and/or by at least one groove on the stripper sleeve. The vent passage may be between the engagement taper and the molding surface of the core. The vent passage or groove may be at least partially described in the engagement taper of the core insert and/or in the second engagement taper of the stripper sleeve.

The or each stripper sleeve may comprise a molding surface. The molding surface of the or each stripper sleeve may describe, e.g. with the molding surface of the or a respective core insert, at least part of an open end of the hollow body. The or each cavity insert may describe, or may comprise a molding surface that describes, at least part of an external surface of the hollow body. The molding surface of the stripper sleeve may describe, e.g. with the cavity insert or molding surface thereof, at least part of an external surface of the hollow body.

The or each stripper sleeve may be movable relative to the stripper plate, for example across a first range of movement. The core insert may be movable across a second range of movement relative to the core plate when it is in the floating condition. The second range of movement may be greater than the first range of movement. The or each stripper sleeve may be retained, e.g. movably retained, on or to the stripper plate by a fastener. The fastener may comprise a bolt and/or may engage, e.g. loosely, a shoulder of the stripper sleeve. The or each stripper sleeve may comprise a recess, which may be part-cylindrical, and/or may describe the or a shoulder. Additionally or alternatively, the fastener may comprise a snap ring. The or each stripper sleeve may be retained, e.g. movably retained, on or to the stripper plate by a snap ring. The snap ring may be received within a groove at or adjacent a first end of the stripper sleeve. The or each stripper sleeve may comprise a flange, e.g. at or adjacent a second end thereof. The stripper plate may be captivated, e.g. loosely captivated, between the flange and the snap ring of the or each stripper sleeve.

The mold assembly may comprise one or more gate inserts. The or each gate insert may cooperate with the or a respective cavity insert to describe a closed end of the hollow body. The or each gate insert may comprise a molding surface, which may cooperate with the or a respective cavity insert, or molding surface thereof, to describe a closed end of the hollow body.

The mold assembly may comprise a gate insert retaining plate, which may be mounted to the cavity plate. The or each gate insert may be mounted to the gate insert retaining plate. The or each gate insert may be in alignment with the or a respective cavity insert. The gate insert retaining plate may comprise one or more holes through its thickness. The or each hole of the gate insert retaining plate may be aligned with the or a respective hole in the cavity plate, e.g. for allowing the tool to be inserted therethrough to access the core insert fastener.

The or each gate insert may comprise an engagement taper. The engagement taper of the gate insert may cooperate with an engagement taper of the or a respective cavity insert. The engagement taper of the cavity insert that cooperates with the first engagement taper of the stripper sleeve may comprise a first engagement taper. The engagement taper of the cavity insert that cooperates with the engagement taper of the gate insert may comprise a second engagement taper. The engagement taper of the gate insert may comprise a male taper. The engagement taper of the cavity insert that cooperates with the engagement taper of the gate insert may comprise a female taper.

The mold assembly may comprise a melt distributor. The gate insert retaining plate may be mounted to the melt distributor. The gate insert retaining plate may form part of or be incorporated in the melt distributor. The or each gate insert may be movable relative to the gate insert retaining plate, for example to enable the or each gate insert to align with the or a respective cavity insert as the melt distributor is mounted, in use, to the cavity plate. The or each gate insert may comprise a first side, which may include the taper. The or each gate insert may comprise a second side, which may comprise a flange or enlarged dimension, diameter or circumference. The or each gate insert may comprise a step, for example a radial step, between the first side and the second side.

The gate insert retaining plate may comprise one or more holes or receptacles, which may be stepped. The or each gate insert may be received within a respective hole or receptacle of or in the gate insert retaining plate. The step of the or each gate insert may engage the step of the hole or receptacle within which it is received. The step of the or each hole or receptacle may retain, for example movably retain, the gate insert, for example when the gate insert retaining plate is mounted to or incorporated within the melt distributor.

The or each gate insert may be mounted to the gate insert retaining plate by a fastener. The fastener may be operable, e.g. when the assembly is in the assembled configuration, to secure the or each gate insert. The fastener may be operable to secure the or each gate insert to a fixed condition, e.g. from a floating or movable condition. The gate insert may be able to move relative to the gate insert retaining plate in the floating or movable condition. The gate insert may be substantially immovable relative to the gate insert retaining plate.

In some examples, the mold assembly comprises one or more gate inserts mounted to the cavity plate. The or each gate insert may be received at least in part within a recess of the or a respective cavity insert. The gate insert(s) may be received within and/or mounted in cooperation with the or a respective cavity insert, e.g. to describe the or a closed end of the hollow body.

The one or more core inserts may comprise a plurality of core inserts. The one or more cavity inserts may comprise a plurality of cavity inserts. The assembly may comprise one or more, e.g. a plurality of, mold stacks. The or each mold stack may comprise the or one of the core insert(s) and the or one of the cavity insert(s). The or each mold stack may comprise the or one of the stripper sleeves. The or each mold stack may comprise the or one of the gate inserts.

Another aspect of the invention provides a molding system. The molding system may comprise a mold as described above. The molding system may comprise an injection molding machine. The machine may have a clamp unit, for example within which is mounted a mold assembly as described above. The machine may have an injection unit, e.g. for injecting molten material between the core insert and cavity insert to mold a hollow body therebetween. The molding system may comprise a material supply system. The molding system may comprise a part removal and/or post mold cooling apparatus.

Another broad aspect of the invention provides a method of aligning a mold or mold assembly. The method may comprise mounting one or more core inserts to a core plate, e.g. such that the or each core insert is able to move along the core plate. The method may comprise bringing together the core plate with one or more other plates, e.g. such that the or each core insert is aligned with one or more other mold insert.

The method may comprise securing the or each core insert to the core plate, e.g. in its aligned position. Securing the or each core insert to the core plate may be carried out via holes in the other plate(s). Securing the or each core insert to the core plate may be carried out without access to a front side of the core plate, e.g. when the assembly is in the assembled configuration. Securing the or each core insert to the core plate may be carried out by operating fastening means accessible or operable from a rear side of the other plate(s).

The method may comprise mounting the or each core insert to the core plate in a movable or floating condition. The or each core insert may be able to move or slide relative to the core plate, e.g. along a sliding interface therebetween, e.g. when the or each core insert is in the movable or floating condition. The method may comprise securing the or each core insert into a fixed and aligned condition. The or each core insert may be immovable relative to the core plate and/or aligned with the other mold insert(s) when they are in the fixed and aligned condition.

Aligning the or each core insert relative to the other mold insert(s) may comprise bringing together the or each core insert and the other mold insert(s) into a closed configuration, e.g. in which the or each core insert is engaged and/or in contact with the other mold insert(s). Aligning the or each core insert(s) relative to the other mold insert(s) may comprise bringing together and separating the or each core insert and the other mold insert(s) one or more times, e.g. more than once. Aligning the or each core insert relative to the other mold insert(s) may comprise repeatedly bringing together and separating the or each core insert and the other mold insert(s).

Securing the or each core insert to the fixed, aligned condition may be performed with the mold insert(s) in the closed configuration, e.g. with the or each core insert engaged and/or in contact with the other mold insert(s). The method may comprise securing the mold inserts in the closed configuration before securing the or each core insert to the fixed, aligned condition.

Bringing together the or each core insert and the other mold insert(s) into a closed configuration may comprise bringing together the core plate and one or more plates to which the or each core insert and/or other insert(s) are mounted. The other inserts may comprise one or more cavity inserts. Bringing together the or each core insert and the other mold insert(s) into a closed configuration may comprise bringing together the core plate and a cavity plate of the mold, e.g. to which the or each cavity insert is mounted. Securing the or each core insert in the fixed, aligned condition may be performed with the core plate mounted to the cavity plate.

The method may comprise mounting one or more cavity inserts to a cavity plate, e.g. such that the or each cavity insert is substantially immovable. The method may comprise bringing together the cavity plate and the core plate, e.g. such that the or each core insert is aligned with the or a respective cavity insert. The method may comprise securing the or each core insert to the core plate, e.g. in its aligned position, such as via holes in the cavity plate.

Another broad aspect of the invention provides a method of aligning a mold comprising: mounting a cavity insert to a cavity plate such that it is substantially immovable; mounting a core insert to a core plate such that it is able to move along the core plate; bringing together the cavity plate and the core plate such that the core insert is aligned with the cavity insert; and securing the core insert to the core plate in its aligned position via holes in the cavity plate.

Another broad aspect of the invention provides a method of aligning a mold comprising: mounting a cavity insert to a cavity plate such that it is substantially immovable; mounting a core insert to a core plate such that it is able to move along the core plate; bringing together the cavity plate and the core plate such that the core insert is aligned with the cavity insert; and securing the core insert to the core plate in its aligned position without access to a front side of the core plate when the assembly is in the assembled configuration and/or by operating fastening means accessible or operable from a rear side of the cavity plate.

The method may comprise securing the core plate relative to the one or more plates, e.g. the cavity plate, by one or more fasteners, for example before securing the or each core insert to the fixed, aligned condition. Securing the core plate relative to the other plate(s) may comprise threadedly engaging one or more fasteners.

The method may comprise mounting a stripper sleeve to a stripper plate, for example such that it is fixed to, or able to move with respect to, the stripper plate. The method may comprise bringing together the cavity plate and the core plate with the stripper plate therebetween, for example such that the core insert is aligned with the cavity insert via the stripper sleeve. The method may comprise securing the core insert to the core plate, e.g. in its aligned position. The method may comprise securing the core insert to the core plate via holes in each of the cavity plate and stripper plate.

At least one or each of the core and cavity inserts may comprise an engagement taper, which may be brought into engagement with an engagement taper of the stripper sleeve when the cavity plate and the core plate are brought together with the stripper plate therebetween. Each of the core insert and cavity insert may comprise an engagement taper that is brought into engagement with an engagement taper of the stripper sleeve when the cavity plate and the core plate are brought together with the stripper plate therebetween, e.g. thereby to align the core insert with the cavity insert.

The method may comprise mounting a gate insert to a gate insert retaining plate or to the cavity plate or to the cavity insert. The gate insert may be mounted to the gate insert retaining plate such that it is able to move with respect thereto. The method may comprise bringing together the gate insert retaining plate and the cavity plate, for example such that the gate insert is aligned with the cavity insert. The method may comprise securing the gate insert relative to the cavity insert in its aligned position.

The gate insert may be secured relative to the cavity insert by securing the gate insert retaining plate to the cavity plate. The gate insert retaining plate may be mounted to or incorporated in a melt distributor, for example when the gate insert retaining plate is secured to the cavity plate. Additionally or alternatively, securing the gate insert relative to the cavity insert may comprise securing the gate insert to the gate insert retaining plate, for example such that it is substantially immovable.

Another aspect of the invention provides a computer program element comprising and/or describing and/or defining a three-dimensional design for use with a simulation means or a three-dimensional additive or subtractive manufacturing means or device, e.g. a three-dimensional printer or CNC machine, the three-dimensional design comprising one or more mold components described above.

Another aspect of the invention provides a method of assembling a mold assembly or mold as described above. Various steps and features of the method will be apparent to the skilled person.

Another aspect of the invention provides a method of molding articles. The method may comprise the use of one of the aforementioned mold stacks, molds, mold assemblies or molding systems. The method may comprise any one or more features or steps relevant to or involving the use of any feature of any of the aforementioned mold stacks, molds, mold assemblies or molding systems.

For the avoidance of doubt, any of the features described herein apply equally to any aspect of the invention. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only with reference to the accompanying drawings in which:

FIG. 1 depicts a section view of a mold stack incorporated within a mold assembly according to a first example;

FIG. 2 is a schematic representation of an injection molding system incorporating the mold assembly of FIG. 1;

FIG. 3 depicts the core insert and core plate forming a core plate assembly of the mold assembly of FIG. 1;

FIG. 4 depicts a partial sectional perspective view of the core plate assembly of FIG. 3 showing a plurality of cores mounted to the core plate;

FIG. 5 depicts a partial sectional perspective view of the stripper plate assembly of the mold assembly of FIG. 1;

FIG. 6 depicts a section view of a mold stack incorporated within a mold assembly according to another example;

FIG. 7 depicts a partial sectional perspective view of a core plate assembly according to another example;

FIG. 8 depicts a section view of a core plate assembly according to another example; and

FIG. 9 depicts a section view of a core plate assembly according to another example.

### DETAILED DESCRIPTION OF THE INVENTION

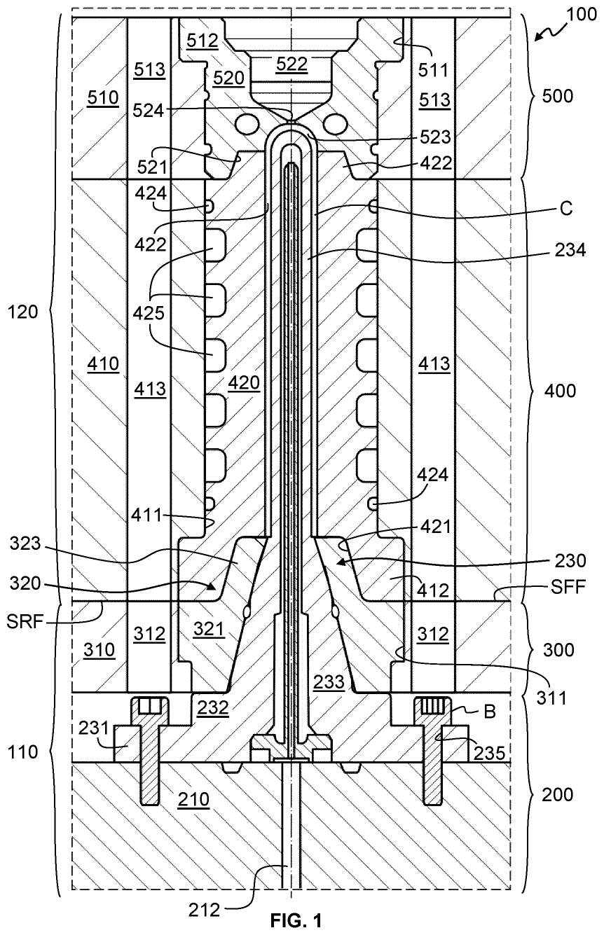

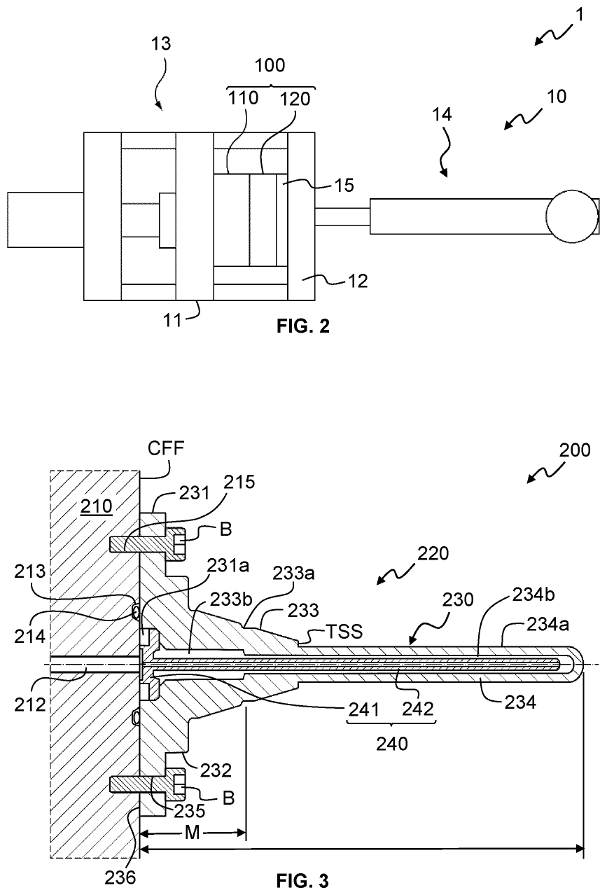

With reference to FIGS. 1 to 5, there is depicted a non-limiting embodiment of a mold assembly 100 according to the invention, which is for mounting in an injection molding machine 10 to form an moulding system 1. The mold assembly 100 describes a plurality of cavities C for manufacturing hollow bodies, specifically vials in this embodiment. The mold assembly 100 includes a first, moving part 110 for mounting to the moving platen 11 of the machine 10 and a second, stationary part 120 for mounting to the stationary platen 12 of the machine 10. The machine 10 includes a clamp unit 13, which incorporates the moving and stationary platens 11, 12, and an injection unit 14 for supplying molten material to the mold assembly 100 via a melt distributor 15.

The first, moving part 110 includes a core plate assembly 200 and a stripper plate assembly 300. The second, stationary part 120 includes a cavity plate assembly 400 and a gate insert retaining plate assembly 500. In some examples, the stationary part 120 also includes the melt distributor 15, commonly referred to as a hot runner. In this embodiment, the melt distributor 15 is of a conventional type and will not be described further.

The core plate assembly 200 includes a core plate 210 and a plurality of core assemblies 220. The core plate 210 is substantially rectangular in plan, includes a network of cooling channels 211, which feed into a plurality of core cooling inlet ports 212 in a front face CFF of the core plate 210. The core cooling inlet ports 212 are arranged in an array of vertical columns and horizontal rows. Each inlet port 212 is surrounded by a circular groove 213 within which is received an annular seal 214. Four holes 215 are spaced equally about each circular groove 213, which include a first pair of threaded holes 215 diagonally opposite one another and a second pair of non-threaded holes diagonally opposite one another.

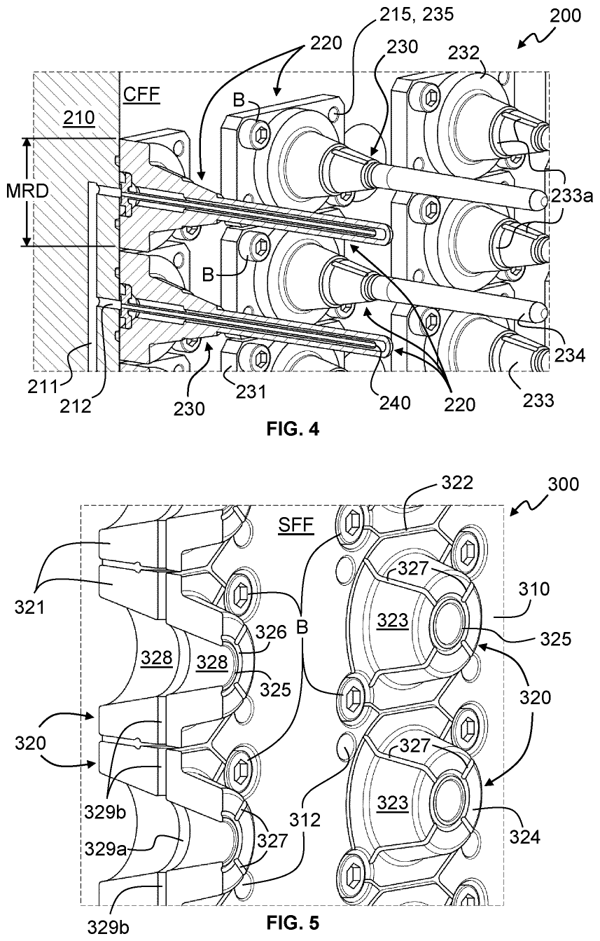

As illustrated more clearly in FIGS. 3 and 4, each core assembly 220 includes a hollow core insert 230 and a core cooling tube 240. Each core insert 230 includes a rectangular mounting flange 231, a cylindrical seat portion 232 projecting from the centre of the mounting flange 231, an engaging taper 233 projecting from the cylindrical seat portion 232 and a substantially cylindrical molding portion 234 projecting from the engaging taper 233. The mounting flange 231 has a minimum radial dimension MRD equivalent to its shorter dimension and includes four holes 235 through its thickness, which are aligned with the holes 214 surrounding one of the core cooling inlet ports 212. Each of the holes 235 of the mounting flange 231 that are aligned with the diagonally opposed pair of threaded holes 215 receives a respective threaded bolt B. The remaining holes 235 of the mounting flange 231 receive dowels (not shown) that engage both the holes 235 of the mounting flange 231 and the non-threaded holes 215 in the core plate 210.

The molding portion 234 has an outer molding surface 234a, for molding an inner surface of a tubular article and a top sealing surface portion TSS for molding an inner portion of the top sealing surface of the tubular article. The core engaging taper 233 extends from the top sealing surface portion TSS to a front surface 232a of the seat portion 232. The core engaging taper 233 includes a network of vents 233a, which are seen more clearly in FIG. 4, for enabling air to be vented from the top sealing surface portion TSS when material is injected into the cavity C.

In this example, each core cooling tube 240 includes an interface portion 241 and an elongate tube portion 242 formed integrally with and extending from the interface portion 241. The interface portion 241 describes a central bore in fluid communication with the elongate tube portion 242, and a series of radial fins with outlet passages described between them. Each core insert 230 includes a central bore formed of a receptacle 231a within the mounting flange 231, a narrower segment 233b within the core engaging taper 233 and a blind segment 234b within the molding portion 234, which is narrower still, and which terminates at a hemispherical or domed, closed end adjacent the free end of the molding portion 234. The diameter of the blind segment 234b is substantially constant and matches the outer contour of the molding portion 234. As such, the wall thickness between the blind segment 234b and the outer molding surface 234a remains substantially constant along the entire molding portion 234.

When the core assembly 220 is mounted to the core plate 210, the interface portion 241 of the core cooling tube 240 is received within the receptacle 231a of the core insert 230 and is centred therein by the radial fins. The interface portion 241 surrounds and is in fluid communication with one of the core cooling inlet ports 212 of the core plate 210. The elongate tube portion 242 extends into the blind segment 234b of the molding portion 234 and terminates adjacent its closed end. A core cooling outlet port (not shown) is adjacent each core cooling inlet port 212, and is communication with an outer portion of the receptacle 231a of the core insert 230. As such, cooling water fed into the cooling channels 211 of the core plate 210 flows into the core cooling tube 240 via the core cooling inlet ports 212, out of the elongate tube portion 242 to impact the closed end of the molding portion 234, and flows back along the elongate tube portion 242, through the outlet passages described between the radial fins of the interface portion 241 and out of the core cooling outlet port (not shown).

In this example, each core insert 230 includes a substantially planar mounting surface 236 at one of its longitudinal ends, which abuts the front face CFF of the core plate 210 and which cooperates with one of the annular seals 214 surrounding a core cooling inlet port 212. As such, when the core inserts 230 are mounted loosely to the front face CFF of the core plate 210 in a floating manner, by loosely tightening the bolts B connecting the core inserts 230 to the core plate 210, the planar mounting surface 236 is able to slide along the front face CFF of the core plate 210.

The skilled person will appreciate that the core engaging taper 233 of the core insert 230 is much closer to the core plate 210 than in conventional core insert designs. More specifically, part of the engagement taper 233 of the core insert 230 is located closer to the mounting surface 236 than it is to the molding portion 234. Put another way, the distance M from the mounting surface 236 of the core to the centre of the core engaging taper 233 is substantially less than in conventional core insert designs. The stability of the core insert 230 relative to the core plate 210 is a function of the ratio between this distance M and the minimum radial dimension MRD. In this example, this distance M is less than the minimum radial dimension MRD.

The stripper plate assembly 300 includes a stripper plate 310 and a plurality of stripper sleeves 320 mounted to the stripper plate 310. The stripper plate 310 is substantially rectangular in plan, corresponding to the shape of the core plate 210, and includes a front face SFF and a rear face SRF, which abuts the front face CFF of the core plate 210. The stripper sleeves 320 are mounted within respective stepped receptacles 311 in the stripper plate 310, and are aligned with the core inserts 230 of the core plate assembly 200 when the stripper plate 310 is mounted to the core plate 210.

As illustrated more clearly in FIG. 5, each stripper sleeve 320 is secured to the stripper plate 310 by a pair of bolts B, which engage respective shoulders (not shown) at opposed corners of the stripper sleeves 320. In this example, the engagement between the bolts B and the stripper sleeves 320 enables some movement, such that the stripper sleeves 320 are able to float across a predetermined range. This allows the stripper sleeves 320 to be repositioned, thereby assisting in proper alignment with the rest of the mold stack. The bolts B are aligned with the holes 215, 235 of the core plate 210 and core inserts 235 that receive the dowels (not shown).

The stripper plate 310 also includes a plurality of holes 312 aligned with the holes 215, 235 of the core plate 210 and core inserts 235 that receive the bolts B. These holes 312 extend through the entire thickness of the stripper plate 310. This is illustrated more clearly in FIG. 1, where it can be seen that the holes 312 are aligned with the bolts B that secure the core inserts 235 to the core plate 310.

Each stripper sleeve 320 has a substantially cylindrical base 321 having a stepped external surface to match that of the stepped receptacle 311 of the stripper plate 310, within which it is received. Each stripper sleeve 320 also includes opposed flats 322 to enable it to be mounted closer to an adjacent stripper sleeve 320 in the column, thereby to minimise the pitch distance and maximise the density of mold stacks to be included in the mold.

Each stripper sleeve 320 also has a frustoconical male taper 323 projecting from the base 321 and narrowing to a flat apex 324. The apex 324 of each stripper sleeve 320 includes a molding surface 325 defining an outer portion of the top sealing surface of a tubular article, which is circumscribed by a circular vent groove 326. Four further vent grooves 327 extend radially from the circular vent groove 327 and axially along the male taper 323. As with the network of vents 233a on the core engaging taper 233 of the core insert 230, the vent grooves 326, 327 on the male taper 323 of the stripper sleeve 320 also enable air to be vented from the molding surface 325 when material is injected into the cavity C. As the molding surface 325 defines part of the top sealing surface of the tubular article, ejection of the tubular article after moulding is effected by moving the stripper plate assembly 300 relative to the core plate assembly 200 such that the tubular article is urged off of the core insert 230 by the molding surface 325 of the stripper sleeve 320.

Each stripper sleeve 320 is hollow with a conical inner surface 328, a central groove 329a extending about its inner periphery and a pair of radial channels 329b extending from the central groove 329, on diametrically opposite sides, to the outside of the stripper sleeve 320. The conical inner surface 328 forms a female taper 328 for engagingly receiving the core engaging taper 233 The female taper 328 of the stripper sleeve 320 extends along the entire length of the stripper sleeve 320 in this example. The central groove 329a aligned with a circumferential groove of the network of vents 233a on the core engaging taper 233 when it is received within the female taper 328 of the stripper sleeve 320. As such, the vents 233a, 329a, 329b cooperate with one another to enable air to be vented between the core insert 230 and the stripper sleeve 320 from the molding surface 325, when material is injected into the cavity C.

The cavity plate assembly 400 includes a cavity plate 410 and a plurality of cavity inserts 420 mounted to the cavity plate 410. The cavity plate 410 is substantially rectangular in plan, corresponding to the shape of the core plate 210 and stripper plate 310. The cavity inserts 420 are mounted within respective stepped receptacles 411 in the cavity plate 410, and are aligned with the core inserts 230 of the core plate assembly 200, the stripper sleeves 320 of the stripper plate assembly 300 when the cavity plate 410 is mounted to the stripper plate 310 and core plate 210.

Each cavity insert 420 is secured to the cavity plate 410 by a pair of bolts (not shown), which extend through holes (not shown) in a flange 412 at opposed corners of the cavity inserts 420. In this example, the engagement between the bolts (not shown) and the cavity inserts 420 renders the cavity insert 420 substantially immovable with respect to the cavity plate 410. In this manner, the cavity inserts 420 provide the location base for the core inserts 230 and the stripper sleeves 320. The bolts (not shown) are aligned with the bolts B securing the stripper sleeves 320 to the stripper plate 310.

The cavity plate 410 also includes a plurality of holes 413 aligned with the holes 312 extending through the stripper plate 310 and the holes 215, 235 of the core plate 210 and core inserts 235 that receive the bolts B. These holes 413 extend through the entire thickness of the cavity plate 410, which is illustrated more clearly in FIG. 1, where it can be seen that the holes 413 are aligned with the bolts B that secure the core inserts 235 to the core plate 310.

Each cavity insert 420 includes a female taper 421 at a first of its ends, for cooperation with the male taper 323 of the stripper sleeve 320, and a male taper 422 at a second of its ends. Each cavity insert also includes a bore along its entire length and open at both ends, which describes a molding surface 423 defining an outer surface of a tubular article. A pair of circumferential seal grooves 424 are included on the outer surface of each cavity insert 420, each of which is adjacent one of the tapers 421, 422 for receiving annular seals (not shown). A series of cooling channel grooves 425 are also included between the circumferential seal grooves 424, in a manner that the skilled person will be familiar.

The gate insert retaining plate assembly 500 includes a gate insert retaining plate 510 and a plurality of gate inserts 520 mounted to the cavity plate 510. The gate insert retaining plate 510 is substantially rectangular in plan, corresponding to the shape of the core plate 210, stripper plate 310 and cavity plate 410. The gate inserts 520 are mounted within respective stepped receptacles 511 in the gate insert retaining plate 510, and are aligned with the core inserts 230 of the core plate assembly 200, the stripper sleeves 320 of the stripper plate assembly 300 and the cavity inserts 420 of the cavity plate assembly 400 when the gate insert retaining plate 510 is mounted to the cavity plate 410, stripper plate 310 and core plate 210.

Each gate insert 520 is secured to the gate insert retaining plate 510 by a pair of bolts (not shown), which extend through holes (not shown) in a flange 512 at opposed corners of the gate inserts 520. In alternative examples, the gate inserts 520 may simply be captivated within one of the stepped receptacles 511 when the gate insert retaining plate 510 is mounted to the melt distributor 15. In this example, the engagement between the bolts B and the gate inserts 520 enables some movement, such that the gate inserts 520 are able to float across a predetermined range. This allows the gate inserts 520 to be repositioned, thereby assisting in proper alignment with the cavity inserts 420. The bolts B are aligned with the bolts B securing the stripper sleeves 320 to the stripper plate 310 and those securing the cavity inserts 420 to the cavity plate 410.

The gate insert retaining plate 510 also includes a plurality of holes 513 aligned with the holes 412 extending through the cavity plate 410, the holes 312 extending through the stripper plate 310 and the holes 215, 235 of the core plate 210 and core inserts 235 that receive the bolts B. These holes 513 extend through the entire thickness of the gate insert retaining plate 510, which is illustrated more clearly in FIG. 1, where it can be seen that the holes 513 are aligned with the bolts B that secure the core inserts 235 to the core plate 310.

Each gate insert 520 is substantially cylindrical in shape with a female taper 521 at a first of its ends, for cooperation with the male taper 422 of the cavity insert 520. Each gate insert 520 also includes a nozzle tip receptacle 522, a molding surface 523 and a gate 524 joining the nozzle tip receptacle 522 to the molding surface 523. The nozzle tip receptacle 522 is shaped to accommodate the tip of a valve-gated injection nozzle (not shown) and associated tip insulator (not shown) in the usual way. The molding surface 523 describes a dome-shaped closed end of a tubular article.

The mold 100 enables a novel method of aligning the mold stacks of the mold 100 by:
i) assembling the cavity plate assembly 400, ensuring that the appropriate torque is applied to the bolts to ensure that the cavity inserts 420 are properly secured to the cavity plate 410;
ii) assembling the gate insert retaining plate assembly 500, with the gate inserts 520 mounted to the gate insert retaining plate 510 such that they are able to float across a predetermined range
iii) mounting the gate insert retaining plate assembly 500 to the cavity plate assembly 400 to form the stationary part 120;
iv) assembling the stripper plate assembly 300, with the stripper sleeves 320 mounted to the stripper plate 310 such that they are able to float across a predetermined range;
v) assembling the core plate assembly 200, with the core inserts 230 mounted to the core plate 210 ensuring that the bolts 218 are only loosely tightened, such that the core inserts 230 are mounted loosely to the front face CFF in a floating manner across a range that is greater than the predetermined ranges across which the stripper sleeves 320 are able to float;
vi) placing the core plate assembly 200 on a substrate such that the front face CFF of the core plate 210 is uppermost;
vii) orienting the stripper plate assembly 300 such that the female tapers 328 of the stripper sleeves 320 are lowermost and lowering the stripper plate assembly 300 onto the core plate assembly 200 to form the moving part 110 shown in FIG. 1;
viii) orienting the stationary part 120 such that the cavity plate assembly 400 is lowermost and lowering the stationary part 120 onto the moving part 110;
ix) lifting and lowering the stationary part 120 relative to the moving part 110 repeatedly, using appropriate lifting gear (not shown), in order to align the core inserts 230 and stripper sleeves 320 relative to the cavity inserts 420;
x) inserting a tool (not shown) through the holes 312, 413, 513 in the stripper, cavity and gate insert retaining plates 310, 410, 510 and torqueing the bolts B securing the core inserts 230 to the core plate 210 to secure the core inserts 230 in a fixed, aligned condition, in which they are immovable relative to the core plate 210 and aligned with the stripper sleeves 320 and cavity inserts 420;
xi) installing latches (not shown) to retain the core, stripper, cavity and gate insert retaining plate assemblies 200, 300, 400, 500 together such that the mold 100 is ready for installation.

In the above method, the cavity inserts 420 are the only stack components which are fixed in place initially. The stripper sleeves 320 are secured to the stripper plate 310 in a floating manner. Similarly, the core inserts 230 are initially mounted in a floating manner. As such, the lifting and lowering of the stationary part 120 in step ix) above causes the female tapers 421 of the fixed cavity inserts 420 to engage the male taper 323 of the stripper sleeve 320, thereby aligning the stripper sleeve 320 relative to the cavity inserts 420. In addition, the female taper 328 of the stripper sleeves 320 engage the core taper 233 of the core inserts 230, thereby aligning the core inserts 230 relative to the stripper sleeves 320.

Whilst the bolts B provide a simple, yet effective means of fixing the core inserts 230 from their floating condition with the mold 100 in an assembled condition, other arrangements are envisaged. For example, the bolts B may be replaced by another fastening means, preferably one which is operable via the holes 312, 413, 513 or at least without access to the front of core plate assembly 200. Moreover and as indicated above, although the mounting surface 236 is free of any projections, the core insert 230 could be provided with a spigot that extends from the mounting surface 236 that is smaller than a seat (not shown) in the core plate 210 associated with the core cooling inlet port 212 to enable some sliding movement therebetween. Indeed, in some examples the spigot may be substantially the same size as the seat (not shown) in the core plate 210.

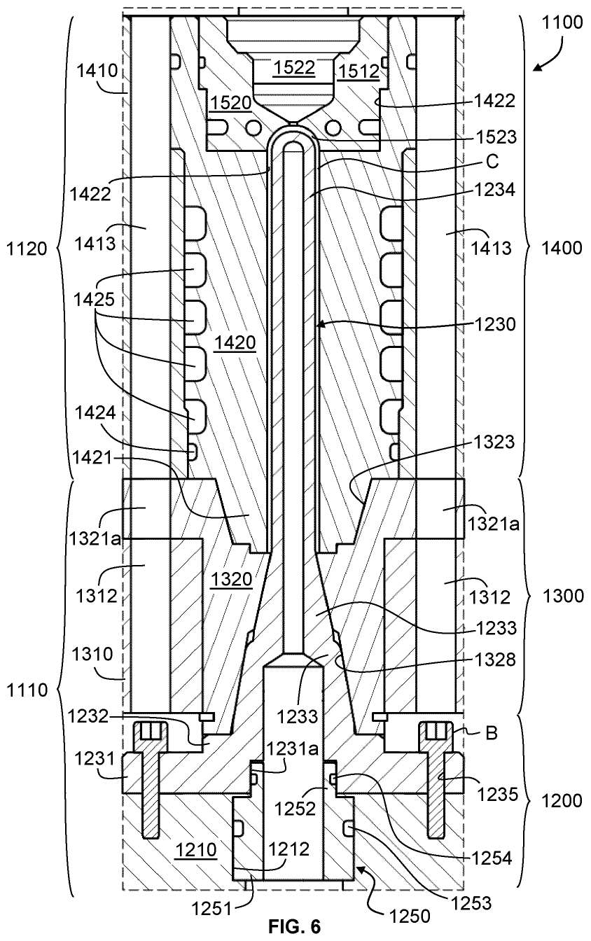

Turning now to FIG. 6, there is shown a mold assembly 1100 according to another example, which is similar to the mold assembly 100 according to the first example, wherein like references depict like features that have been incremented by 1000 and will not be described further. The mold assembly 1100 according to this example differs from that of the first example in that the tapers 1323, 1421 between the stripper sleeve 1320 and the cavity inserts 1420 are reversed, the gate inserts 1520 are received within stepped receptacles 1422 of the cavity inserts 1420 and an interface member 1250 sealingly joins the receptacle 1231a of the core insert 1230 to a seat 1212 in the core plate 1210.

In this example, the stripper sleeve 1320 includes a further female taper 1323 in place of the male taper 323 according to the first example. The further female taper 1323 cooperates with a male taper 1421 of the cavity insert 1420. As such, the female taper 1328 that cooperates with the male taper 1233 of the core insert 1230 does not extend the entire length of the stripper sleeve 1320. However, the length of the male taper 1233 of the core insert 1230 is much longer than that of the cavity insert 1420, so as to maximise the support to the relatively long core insert 1230. As such, the female taper 1328 that cooperates with the male taper 1233 of the core insert 1230 extends along more than half of the length of the stripper sleeve 1320.

Moreover, the gate insert retaining plate 510 is omitted and the cavity plate assembly 1400 incorporates the gate inserts 1520. As such, the cavity plate assembly 1400 corresponds to the stationary part 1120 of the mold 1100. The interface member 1250 is substantially cylindrical with a stepped outer surface describing an enlarged base 1251 received within the seat 1212 in the core plate 1210 and an undersized spigot 1252 extending into the receptacle 1231a of the core insert 1230. The base 1251 is slightly smaller than the seat 1212 within which it is received, in order to allow the core insert 1230 to float relative to the core plate 1210, as described above. Each of the base 1251 and the spigot 1252 include a respective circumferential groove 1253, 1254 that receives an annular seal (not shown) for providing a sealed connection. A core cooling tube (not shown) is received within the core insert 1230, which receives cooling water from the seat 1212 in the core plate 1210 and delivers it to the internal surfaces of the core insert 1230 in a similar manner to that which is described above in relation to the first example.

Alignment of the core inserts 1230 is carried out using a similar method to that which is described above, save for the assembly of the gate insert retaining plate assembly 500 with the cavity plate assembly 400.

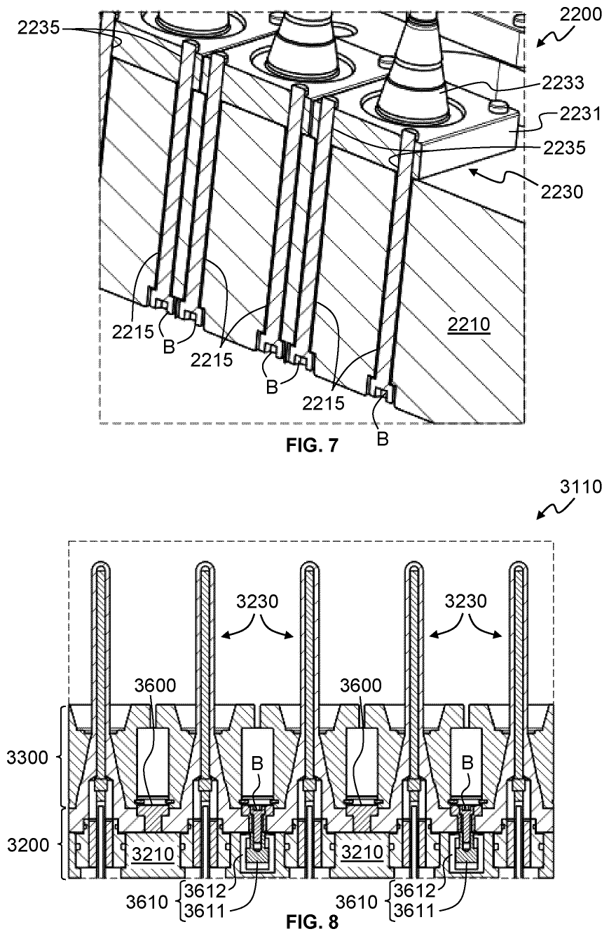

Turning now to FIG. 7, there is shown a core plate assembly 2200 according to another example, which is similar to the core plate assembly 200 according to the first example, wherein like references depict like features that have been incremented by 2000 and will not be described further. The core plate assembly 2200 according to this example differs from that of the first example in that the core plate 2210 includes four through holes 2215 for each core insert 2230 and each core insert 2230 includes four corresponding threaded holes 2235. Bolts B are inserted through the holes 2215 in the core plate 2210 from a rear side RS of the core plate 2210, and threadedly engage the holes 2235 in the core insert 2230.

In this way, the bolts B are operable from the rear side RS of the core plate 2210, when the assembly is in an assembled configuration, to secure the core inserts 2230 from the floating condition to the fixed condition. The method of aligning the mold described above would be modified, as would be appreciated by those skilled in the art. For example, step x) may be omitted and, following step xi), the mold could be inverted with the latches installed, thereby providing access to the bolts B.

FIG. 8 shows a moving part 3110 incorporating a core plate assembly 3200 according to another example, which is similar to the core plate assembly 200 according to the first example, wherein like references depict like features that have been incremented by 3000 and will not be described further. The core plate assembly 3200 according to this example differs from that of the previous examples in that the bolts B are replaced with a clamp plate 3600 operated by hydraulic actuators 3610 incorporated within the core plate 3210, one of which is located between every other pair of core inserts 3230. Each hydraulic actuator 3610 includes a piston 3611 secured to the clamp plate 3600 by a bolt B and slidably received within a cylinder 3612 embedded within the core plate 3210.

In practice, the hydraulic actuators 3610 will be connected to a source of pressurized hydraulic fluid, for example via a valve means to control their actuation. As such, the hydraulic actuators 3610 are operable without any access to either side of the assembled mold. Thus, the method of aligning the mold described above could be used, with step x) being replaced with a simple command to operate the hydraulic actuators 3610.

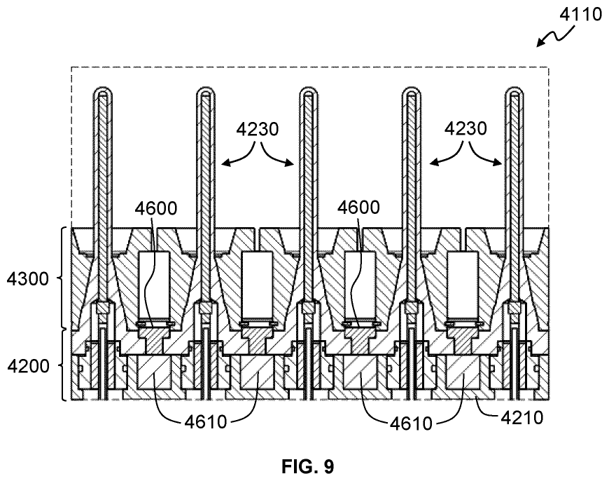

FIG. 9 shows a moving part 4110 incorporating a core plate assembly 4200 according to another example, which is similar to the core plate assembly 200 according to the first example, wherein like references depict like features that have been incremented by 4000 and will not be described further. The core plate assembly 4200 according to this example differs from that of the core plate assembly 3200 in the immediately preceding example in that magnetic actuators 4610 replace the hydraulic actuators 3610.

It will be appreciated by those skilled in the art that several variations to the construction and/or use of aforementioned examples are envisaged without departing from the scope of the invention. It will also be appreciated by those skilled in the art that any number of combinations of the aforementioned features and/or those shown in the appended drawings provide clear advantages over the prior art and are therefore within the scope of the invention described herein.

1. A mold assembly for making tubular articles, the assembly comprising:
a core plate;
one or more core inserts each mounted at first of its longitudinal ends to the core plate, the or each core insert comprising a molding surface describing an inner surface of a hollow body and an engagement taper between the molding surface and the first longitudinal end;
wherein at least part of the engagement taper is located closer to the first longitudinal end than it is to the molding surface for inhibiting the core insert from tipping when the engagement taper is engaged to move or slide the core insert along the core plate.

2. A mold assembly according to claim 1, wherein the or each core insert is mounted to the core plate by fastening means operable, when the assembly is in an assembled configuration, to secure the or each core insert from a floating condition, in which the or each core insert is able to move relative to the core plate along a sliding interface therebetween, to a fixed condition, in which the or each core insert is substantially immovable relative to the core plate.

3. A mold assembly as claimed in claim 2, wherein the or each core insert comprises a mounting portion for mounting the core insert to the core plate, the mounting portion comprising:
a mounting flange at a first longitudinal end of the core insert, which is configured to receive the core insert fastener to secure the core insert to a core plate; and
the engagement taper which cooperates with the second engagement taper of the stripper sleeve;
wherein the engagement taper is located between the molding surface and the mounting flange.

4. A mold assembly according to claim 3, wherein the mounting flange of the or each core has a radial dimension that is at least one third of the distance from the first longitudinal end to a longitudinal centre of the engagement taper.

5. A mold assembly according to claim 3, wherein the mounting flange of the or each core has a radial dimension that is at least half of the distance from the first longitudinal end to a longitudinal centre of the engagement taper.

6. A mold assembly according to claim 3, wherein the mounting flange of the or each core has a radial dimension that is at least two thirds of the distance from the first longitudinal end to a longitudinal centre of the engagement taper.

7. A mold assembly according to claim 1 comprising:
at least one further mold plate; and
one or more further mold inserts mounted to the or each further mold plate, the or each further mold insert comprising an engagement taper;
wherein, in the assembled configuration, the core plate is mounted to the further mold plate(s), with the fastening means therebetween, such that each core insert describes with a respective further mold insert at least part of a hollow body and the engagement taper of the or each core insert is in engagement directly or indirectly with the engagement taper of at least one of the further mold insert(s).

8. A mold assembly according to claim 7, wherein the further mold plates comprise:
a cavity plate with one or more cavity inserts mounted thereto;
a stripper plate between the core plate and cavity plate with one or more stripper sleeves mounted thereto;
the or each stripper sleeve comprising:
a first side with a first engagement taper which cooperates with an engagement taper of the cavity insert; and
a second side with a second engagement taper which cooperates with the engagement taper of a core insert.

9. A mold assembly according to claim 8, wherein the engagement taper of the core insert is a male taper and the second engagement taper of the stripper sleeve is a female taper which extends from the second side along at least half of the length of the stripper sleeve.

10. A mold assembly according to claim 8, wherein the or each stripper sleeve is movable relative to the stripper plate.

11. A mold assembly according to claim 10, wherein the or each stripper sleeve is movable relative to the stripper plate across a first range of movement and the core insert is movable across a second range of movement relative to the core plate when it is in the floating condition, the second range of movement being greater than the first range of movement.

12. A mold assembly according to claim 7, wherein the fastening means comprises a fastener and the or each further mold plate comprises one or more holes through its thickness and the or each hole is aligned with a respective core insert fastener for allowing a tool to be inserted therethrough to access the core insert fastener.

13. A mold assembly according to claim 1 comprising:
a gate insert retaining plate mounted to the cavity plate; and
one or more gate inserts mounted to the gate insert retaining plate in alignment with the or a respective cavity insert and cooperating therewith to describe a closed end of the hollow body;
wherein the gate insert retaining plate comprises one or more holes through its thickness and the or each hole is aligned with the or a respective hole in the cavity plate for allowing the tool to be inserted therethrough to access the core insert fastener.

14. A mold assembly according to claim 13, wherein the or each gate insert comprises an engagement taper which cooperates with an engagement taper of the or a respective cavity insert.

15. A mold assembly according to claim 14 comprising a melt distributor to which the gate insert retaining plate is mounted or within which it is incorporated, wherein the or each gate insert is movable relative to the gate insert retaining plate to enable the or each gate insert to align with the or a respective cavity insert as the melt distributor is mounted, in use, to the cavity plate.

16. A mold assembly according to claim 14, wherein the or each gate insert is mounted to the gate insert retaining plate by a fastener which is operable, when the assembly is in the assembled configuration, to secure the or each gate insert from a floating condition, in which it is able to move relative to the gate insert retaining plate, to a fixed condition, in which it is substantially immovable relative to the gate insert retaining plate.

17. A mold assembly according to claim 2, wherein the fastening means comprises a clamping mechanism operable to releasably clamp, in use, the core insert(s) to secure it or them from the floating condition to the fixed condition.

18. A mold assembly according to claim 17, wherein the clamping mechanism comprises an actuator.

19. A mold assembly according to claim 18, wherein the actuator is operated hydraulically, pneumatically or magnetically.

20. A molding system comprising an injection molding machine having a clamp unit within which is mounted a mold assembly according to claim 1 and an injection unit for injecting molten material between the core insert and cavity insert to mold a hollow body therebetween.

21. A core insert for use in a mold, the core insert comprising:
a molding surface which describes an inner surface of a hollow body; and
a mounting portion for mounting the core insert to a core plate, the mounting portion comprising:
a mounting flange at a first longitudinal end of the core insert, which is configured to receive a fastener to secure the core insert to a core plate; and
an engagement taper between the molding surface and the mounting flange for engaging a cooperating engagement taper of a further mold insert;
wherein at least part of the engagement taper is located closer to the first longitudinal end than it is to the molding surface.

22. A stripper sleeve for use in a mold, the stripper sleeve comprising:
a first side with a first engagement taper for cooperating with an engagement taper of a cavity insert; and
a second side with a second engagement taper for cooperating with an engagement taper of a core insert;
wherein the second engagement taper is a female taper and extends from the second side along at least half of the length of the stripper sleeve.

23. A method of aligning a mold comprising:
mounting a cavity insert to a cavity plate such that it is substantially immovable;
mounting a core insert to a core plate such that it is able to move along the core plate;
bringing together the cavity plate and the core plate such that the core insert is aligned with the cavity insert; and
securing the core insert to the core plate in its aligned position via holes in the cavity plate.

24. A method according to claim 23 comprising:
mounting a stripper sleeve to a stripper plate such that it is able to move with respect to the stripper plate;
bringing together the cavity plate and the core plate with the stripper plate therebetween such that the core insert is aligned with the cavity insert via the stripper sleeve; and
securing the core insert to the core plate in its aligned position via holes in each of the cavity plate and stripper plate.

25. A method according to claim 24, wherein each of the core and cavity inserts comprises an engagement taper that is brought into engagement with a respective engagement taper of the stripper sleeve when the cavity plate and the core plate are brought together with the stripper plate therebetween, thereby to align the core insert with the cavity insert.
